(19) United States
(12) Patent Application Publication
(10) Pub. No.: US 2017/0328483 A1
(43) Pub. Date: Nov. 16, 2017

(54) GREYWATER CONTROL VALVE

(71) Applicants: Candy Vanderhoff, San Diego, CA (US); David Schuler, Ramona, CA (US)

(72) Inventors: Candy Vanderhoff, San Diego, CA (US); David Schuler, Ramona, CA (US)

(21) Appl. No.: 15/596,866

(22) Filed: May 16, 2017

Related U.S. Application Data
(60) Provisional application No. 62/337,242, filed on May 16, 2016.

(51) Int. Cl. F16K 11/085; E03C 1/122

(52) U.S. Cl. CPC F16K 11/0853; E03C 1/122

(57) ABSTRACT

A greywater control valve includes: a housing having an input port and at least two output ports; and an insert including a port connection element and a vent. A rotary greywater control valve includes: a housing including: an input port; a first output port; and a second output port; and an insert that rotates within the housing, the insert including: a connection channel that couples the input port to one of the first output port and the second output port; and a vent channel that couples the connection channel to one of the output ports. A fluid control valve includes: an input port located along a first axis; a first output port located along a second axis that is perpendicular to the first axis; a second output port located along the second axis; and a fluid channel that selectively couples the input port to one of the output ports.

### CROSS-REFERENCE TO RELATED APPLICATIONS

This application claims priority to U.S. Provisional Patent Application Ser. No. 62/337,242, filed on May 16, 2016.

### BACKGROUND

Many people may wish to utilize greywater, or gently used water from, for instance, bathroom sinks, showers, tubs, dishwashers, and washing machines. Such water may not be potable, but may still be used for purposes such as irrigation or indoor reuse (e.g., for flushing toilets).

In some cases, the uses (such as irrigation) may not require all available greywater (e.g., when there has been sufficient rainfall) and users may wish to easily dispose of the greywater to an alternative destination (e.g., an indoor plumbing system).

Therefore there exists a need for a greywater control valve that is able to be installed without requiring extensive intrusion into existing systems and that allows for distribution of greywater to multiple recipient systems.

### SUMMARY

Some embodiments provide a fluid control valve. The valve may be used to select a destination for a greywater source. The valve may include a rotating insert that is used to select the destination.

The rotating insert may include a fluid channel and/or a vent channel in some embodiments. The fluid channel may connect an input port to a selected output port. The vent channel may connect the fluid channel to an unselected output port.

In some embodiments, the fluid channel may form an arc or elbow that traverses ninety degrees across the face of the valve. In such cases, the input port may be along a first axis while two output ports are along a second axis that is perpendicular to the first axis.

The valve may be able to be mounted on a wall or flat surface and connected to a source and destinations using various appropriate connectors, such as tubes, pipe, hoses, etc.

Some embodiments may include a quick release insert that allows the insert to be easily removed from the housing for cleaning or maintenance.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1A illustrates a front elevation view of a greywater control valve according to an exemplary embodiment;

FIG. 1B illustrates a top plan view of the greywater control valve of FIG. 1A;

FIG. 1C illustrates a bottom plan view of the greywater control valve of FIG. 1A;

FIG. 1D illustrates a left side elevation view of the greywater control valve of FIG. 1A;

FIG. 1E illustrates a right side elevation view of the greywater control valve of FIG. 1A;

FIG. 1F illustrates a top, front, left side perspective view of the greywater control valve of FIG. 1A;

FIG. 1G illustrates a top, front, right side perspective view of the greywater control valve of FIG. 1A;

FIG. 1H illustrates a bottom, front, left side perspective view of the greywater control valve of FIG. 1A;

FIG. 1I illustrates a bottom, front, right side perspective view of the greywater control valve of FIG. 1A;

FIG. 2A illustrates a front elevation view of a greywater control valve housing of the greywater control valve of FIG. 1A;

FIG. 2B illustrates a top plan view of the greywater control valve housing of FIG. 2A;

FIG. 2C illustrates a bottom plan view of the greywater control valve housing of FIG. 2A;

FIG. 2D illustrates a left side elevation view of the greywater control valve housing of FIG. 2A;

FIG. 2E illustrates a right side elevation view of the greywater control valve housing of FIG. 2A;

FIG. 2F illustrates a top, front, left side perspective view of the greywater control valve housing of FIG. 2A;

FIG. 2G illustrates a top, front, right side perspective view of the greywater control valve housing of FIG. 2A;

FIG. 2H illustrates a bottom, front, left side perspective view of the greywater control valve housing of FIG. 2A;

FIG. 2I illustrates a bottom, front, right side perspective view of the greywater control valve housing of FIG. 2A;

FIG. 3A illustrates a front elevation view of a greywater control valve insert of the greywater control valve of FIG. 1A;

FIG. 3B illustrates a bottom, left plan view of the greywater control valve insert of FIG. 3A;

FIG. 3C illustrates a bottom, right plan view of the greywater control valve insert of FIG. 3A;

FIG. 3D illustrates a left side elevation view of the greywater control valve insert of FIG. 3A;

FIG. 3E illustrates a right side elevation view of the greywater control valve insert of FIG. 3A;

FIG. 3F illustrates a top, front, left side perspective view of the greywater control valve insert of FIG. 3A;

FIG. 3G illustrates a top, front, right side perspective view of the greywater control valve insert of FIG. 3A;

FIG. 3H illustrates a bottom, front perspective view of the greywater control valve insert of FIG. 3A;

FIG. 3I illustrates a bottom, front, right side perspective view of the greywater control valve insert of FIG. 3A;

FIG. 4A illustrates a left side plan view of the greywater control valve insert of FIG. 3A;

FIG. 4B illustrates a front elevation section view of the greywater control valve insert of FIG. 4A; and

FIG. 5A illustrates a front elevation view of a quick release greywater control valve according to an exemplary embodiment;

FIG. 5B illustrates a top plan view of the quick release greywater control valve of FIG. 5A;

FIG. 5C illustrates a bottom plan view of the quick release greywater control valve of FIG. 5A;

FIG. 5D illustrates a left side elevation view of the quick release greywater control valve of FIG. 5A;

FIG. 5E illustrates a right side elevation view of the quick release greywater control valve of FIG. 5A;

FIG. 5F illustrates a top, front, left side perspective view of the quick release greywater control valve of FIG. 5A;

FIG. 5G illustrates a top, front, right side perspective view of the quick release greywater control valve of FIG. 5A;

FIG. 5H illustrates a bottom, front, left side perspective view of the quick release greywater control valve of FIG. 5A;

FIG. 5I illustrates a bottom, front, right side perspective view of the quick release greywater control valve of FIG. 5A;

FIG. 6A illustrates a front elevation view of a quick release greywater control valve housing of the greywater control valve of FIG. 5A;

FIG. 6B illustrates a top plan view of the quick release greywater control valve housing of FIG. 6A;

FIG. 6C illustrates a bottom plan view of the quick release greywater control valve housing of FIG. 6A;

FIG. 6D illustrates a left side elevation view of the quick release greywater control valve housing of FIG. 6A;

FIG. 6E illustrates a right side elevation view of the quick release greywater control valve housing of FIG. 6A;

FIG. 6F illustrates a top, front, left side perspective view of the quick release greywater control valve housing of FIG. 6A;

FIG. 6G illustrates a top, front, right side perspective view of the quick release greywater control valve housing of FIG. 6A;

FIG. 6H illustrates a bottom, front, left side perspective view of the quick release greywater control valve housing of FIG. 6A;

FIG. 6I illustrates a bottom, front, right side perspective view of the quick release greywater control valve housing of FIG. 6A;

FIG. 7A illustrates a front elevation view of a quick release greywater control valve insert of the quick release greywater control valve of FIG. 5A;

FIG. 7B illustrates a bottom, left plan view of the quick release greywater control valve insert of FIG. 7A;

FIG. 7C illustrates a bottom, right plan view of the quick release greywater control valve insert of FIG. 7A;

FIG. 7D illustrates a left side elevation view of the quick release greywater control valve insert of FIG. 7A;

FIG. 7E illustrates a right side elevation view of the quick release greywater control valve insert of FIG. 7A;

FIG. 7F illustrates a top, front, left side perspective view of the quick release greywater control valve insert of FIG. 7A;

FIG. 7G illustrates a top, front, right side perspective view of the quick release greywater control valve insert of FIG. 7A;

FIG. 7H illustrates a bottom, front perspective view of the quick release greywater control valve insert of FIG. 7A;

FIG. 7I illustrates a bottom, front, right side perspective view of the quick release greywater control valve insert of FIG. 7A;

FIG. 8 illustrates a flow chart of an exemplary greywater control valve installation process of some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a greywater control valve. The valve may include an inlet port and two or more outlet ports. In some embodiments, deselected output ports may provide venting for the selected port.

A first exemplary embodiment provides a greywater control valve comprising: a housing having an input port and at least two output ports; and an insert coupled to the housing, the insert comprising a port connection element and a vent channel.

A second exemplary embodiment provides a rotary greywater control valve comprising: a housing including: an input port; a first output port; and a second output port; and an insert that rotates within the housing, the insert including: a connection channel that couples the input port to one of the first output port and the second output port; and a vent channel that couples the connection channel to one of the first output port and the second output port.

A third exemplary embodiment provides a fluid control valve comprising: an input port comprising a cylindrical element located along a first axis; a first output port comprising a first cylindrical element located along a second axis that is perpendicular to the first axis; a second output port comprising a second cylindrical element located along the second axis; and a fluid channel that selectively couples the input port to one of the first output port and the second output port.

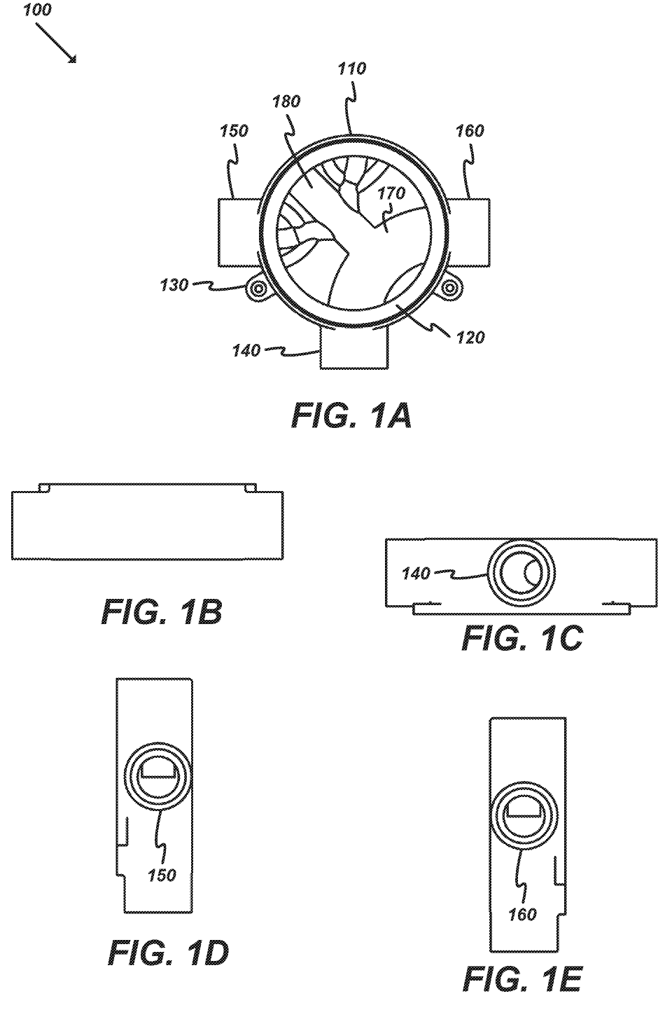

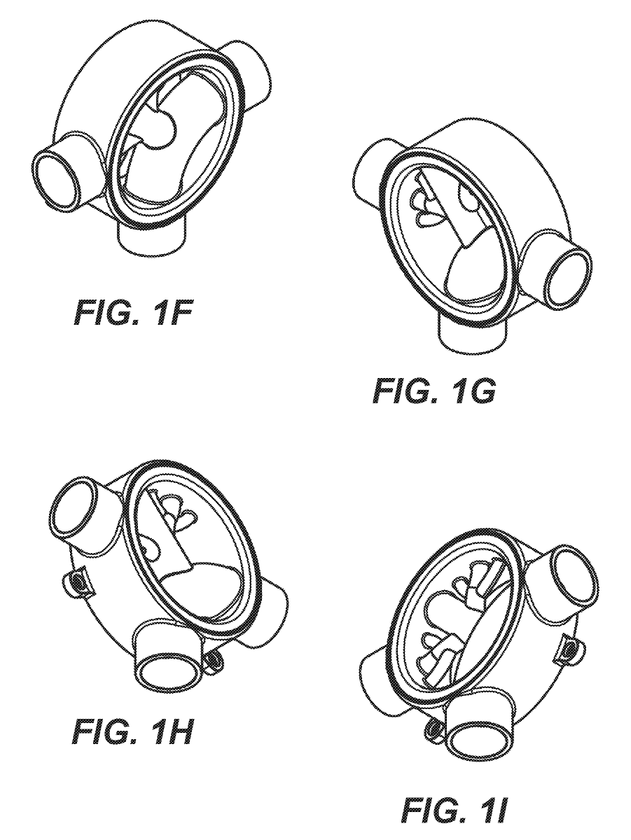

FIG. 1A illustrates a front elevation view of a greywater control valve 100 according to an exemplary embodiment. FIG. 1B illustrates a top plan view of the greywater control valve 100. FIG. 1C illustrates a bottom plan view of the greywater control valve 100. FIG. 1D illustrates a left side elevation view of the greywater control valve 100. FIG. 1E illustrates a right side elevation view of the greywater control valve 100. FIG. 1F illustrates a top, front, left side perspective view of the greywater control valve 100. FIG. 1G illustrates a top, front, right side perspective view of the greywater control valve 100. FIG. 1H illustrates a bottom, front, left side perspective view of the greywater control valve 100. FIG. 1I illustrates a bottom, front, right side perspective view of the greywater control valve 100.

As shown, the greywater control valve may include a housing 110, an insert 120, one or more mounting features 130, an inlet (or “input”, or “inflow”) port 140, a first outlet (or “output”, or “outflow”) port 150, a second outlet port 160, a fluid channel 170, and a vent channel 180. The various components may be made or formed from various appropriate materials (e.g., plastic, rubber, glass, metal, composites, silicon, etc.) that are able to withstand exposure to water.

In addition to the elements shown in this view, some embodiments may include a vent, knobs or other user interface features, and/or other appropriate elements (e.g., water meter displays, electronic switches, etc.). Some embodiments may include various o-rings, gaskets, and/or other sealing elements at various appropriate locations (e.g., at the intersection of the port connection element and port(s), around the insert, etc.).

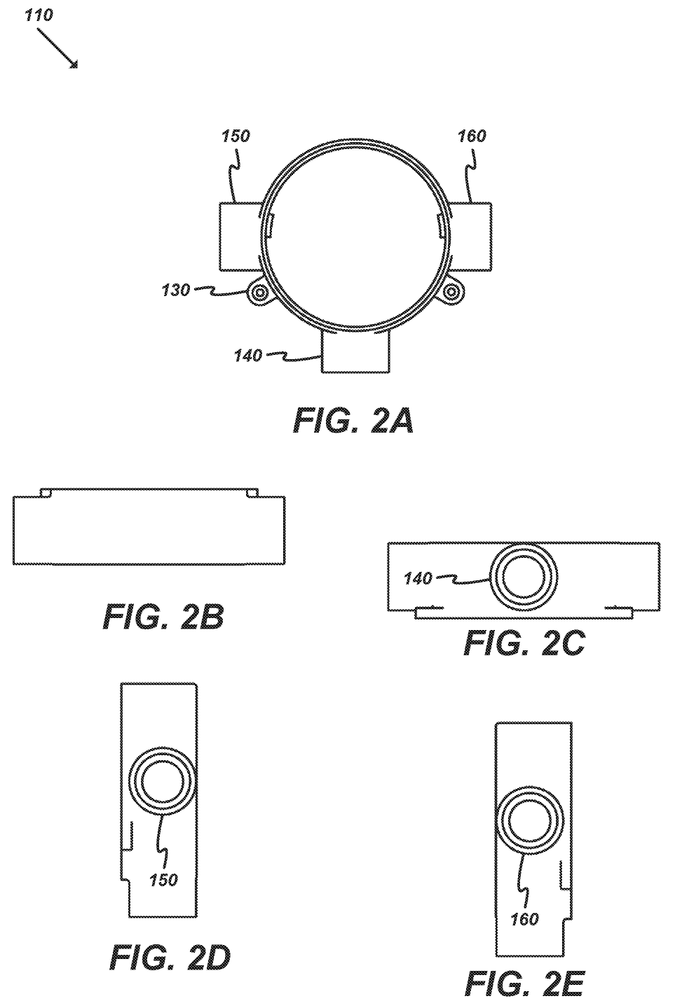

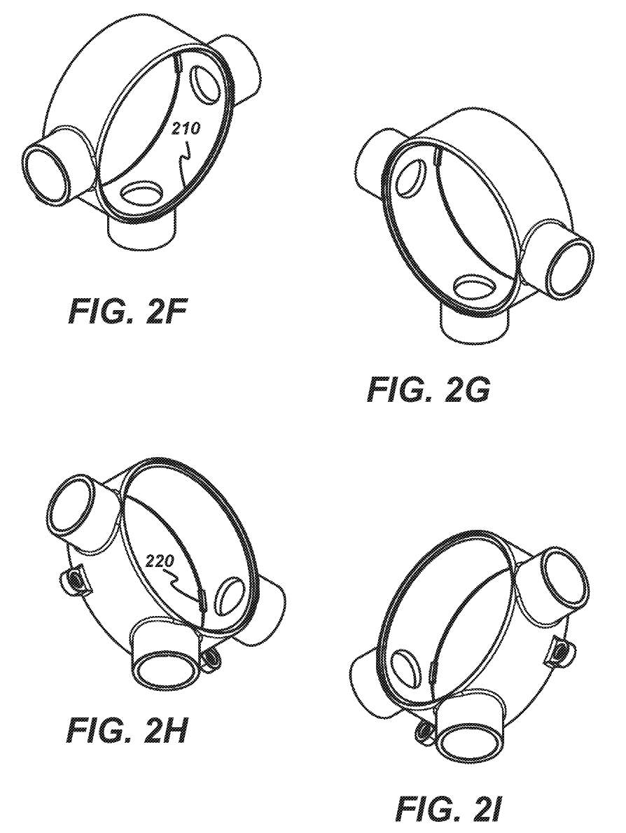

The housing 110 may be made from a single piece of plastic (or other appropriate material) in some embodiments. As shown, the housing may include a flat rear face such that the housing may be mounted on a wall or other surface without requiring demolition or modification of existing plumbing. The housing will be described in more detail in reference to FIG. 2A-FIG. 2I below.

The one or more mounting features 130 may include protruding tabs with through holes that are able to accept screw-type fasteners, as shown. Different embodiments may have different numbers of mounting features. Other mounting features may include, for instance, tape or adhesive, magnets, hooks, mounting plates, etc.

The inlet port 140 may be coupled to a greywater source such as a washing machine. In this example, the input port is positioned at the bottom of the housing 110 and the output ports 150 and 160 are perpendicular to the input port 140 (and parallel to each other), while the fluid channel 170 forms a ninety degree connection. The first outlet port 150 may be coupled to a first output such as a drain that flows to a sewer or septic tank. The second outlet port 160 may be coupled to a second output such as an irrigation system.

Different embodiments may include different numbers of ports (e.g., multiple inlet ports, additional output ports, etc.). The ports may be arranged in various different configurations (e.g., perpendicular as shown, at one hundred twenty degree intervals, etc.), as appropriate for the number of ports and/or other appropriate criteria.

The ports 140-160 may be sized appropriately for connection to standard tubes, hoses, pipes, etc. In some embodiments, the ports may include various clamps or other securing elements that may be able to retain a hose or other such connector. The ports may include tapered elements (i.e., tapered cylinders or conically shaped elements) that allow for direct connection to hoses or other appropriate elements (and/or other appropriate connecting elements such as threaded connectors, compression fit connectors, etc.). Some embodiments may include metal fittings (e.g., copper tubing) that allow for solder connections. Water meters (and associated electronic circuitry) may be included at one or more of the ports that are each able to measure the volume of water that passes through the associated port.

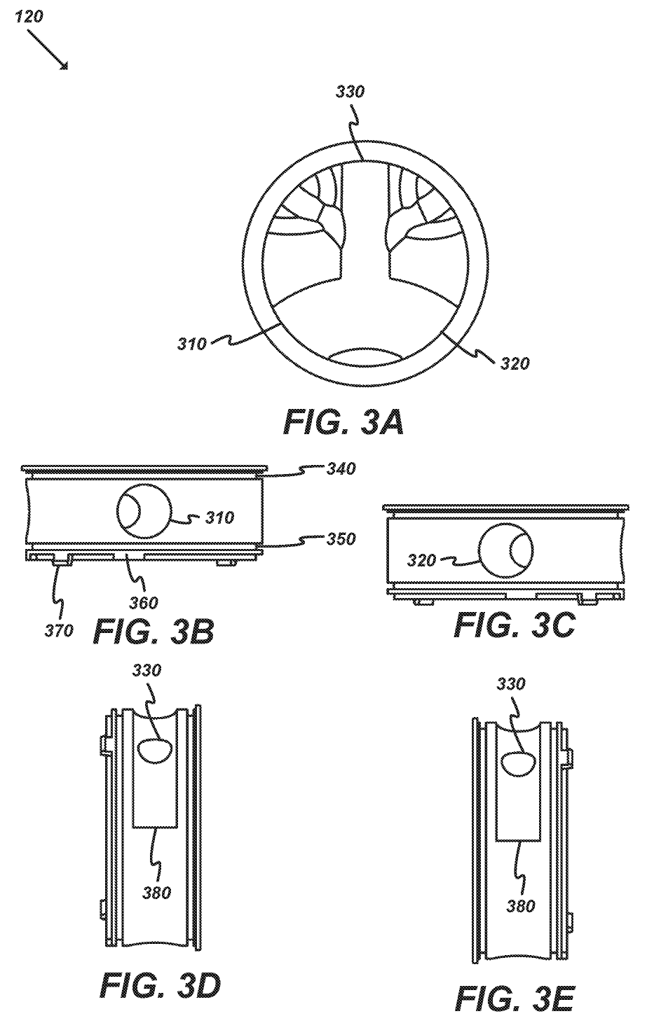

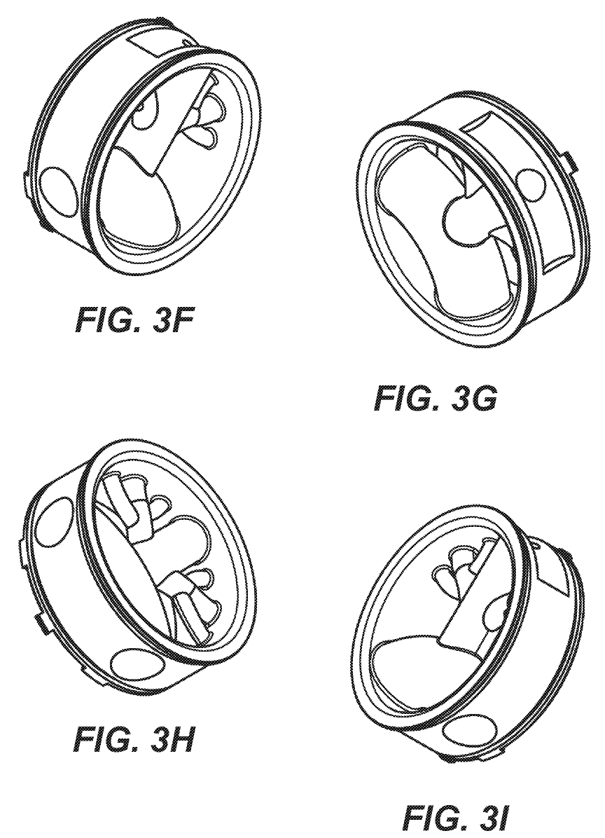

The insert 120 may be able to fit within the housing 110 such that the insert 120 may be rotated within the housing 110 about an axis of rotation that extends straight out from the view of FIG. 1A and that is perpendicular to the ports 140-160. The fluid channel 170 may connect the input port 140 to one of the output ports (port 160 in this example). The fluid channel 170 may include a cylindrical, pipe-shaped pathway. The vent channel 180 may allow airflow through the unused output port (port 150 in this example). The vent channel 180 may include a cylindrical, pipe-shaped pathway. The insert will be described in more detail in reference to FIG. 3A-FIG. 3I below.

During use, the insert 110 may be rotated to select from among the output ports 150-160. For instance, in FIG. 1A, input port 140 is coupled to output port 160 via channel 170 (also referred to as “second position” in this example). The insert 110 may be rotated clockwise ninety degrees such that the input port 140 is coupled to output port 150 (also referred to as “first position” in this example). Such rotation will also couple the vent channel 180 to the unused output port. In some embodiments, the rotation may be limited by various “stops” such that a user may turn the insert 110 from the first position to the second position.

FIG. 2A illustrates a front elevation view of a greywater control valve housing 110 of the greywater control valve 100. FIG. 2B illustrates a top plan view of the greywater control valve housing 110. FIG. 2C illustrates a bottom plan view of the greywater control valve housing 110. FIG. 2D illustrates a left side elevation view of the greywater control valve housing 110. FIG. 2E illustrates a right side elevation view of the greywater control valve housing 110. FIG. 2F illustrates a top, front, left side perspective view of the greywater control valve housing 110. FIG. 2G illustrates a top, front, right side perspective view of the greywater control valve housing 110. FIG. 2H illustrates a bottom, front, left side perspective view of the greywater control valve housing 110. FIG. 2I illustrates a bottom, front, right side perspective view of the greywater control valve housing 110.

As shown, the housing 110, may include a protruding ridge 210 and one or more tabs 220. Such elements may be used to secure the insert 120 within the housing 110 such that the insert 120 may be rotated within the housing 110. In some embodiments, the insert 120 may be inserted into the housing 110 from the rear such that the insert 120 is secured in place when the housing 110 is mounted to a wall or other surface. The insert 0120 may be able to be removed from the housing 110 at a particular angle of rotation (e.g., by aligning the tabs 220 with associated slots). In some embodiments, the insert 120 may have a compression fit within the housing 110 such that no gaskets or seals are needed between the insert 120 and the housing 110.

FIG. 3A illustrates a front elevation view of a greywater control valve insert 120 of the greywater control valve 100. FIG. 3B illustrates a bottom, left plan view of the greywater control valve insert 120. FIG. 3C illustrates a bottom, right plan view of the greywater control valve insert 120. FIG. 3D illustrates a left side elevation view of the greywater control valve insert 120. FIG. 3E illustrates a right side elevation view of the greywater control valve insert 120. FIG. 3F illustrates a top, front, left side perspective view of the greywater control valve insert 120. FIG. 3G illustrates a top, front, right side perspective view of the greywater control valve insert 120. FIG. 3H illustrates a bottom, front perspective view of the greywater control valve insert 120. FIG. 3I illustrates a bottom, front, right side perspective view of the greywater control valve insert 120.

As shown, the insert 120 may include a first input/output port 310, a second input/output port 320, a vent port 330, a first channel 340, a second channel 350, one or more slots 360, one or more tabs 370, and a vent cavity 380.

The first input/output port 310 may be connected to the second input/output port 320 by a curved cylindrical member or pipe 170 that is able to selectively connect the input port 140 to one or more of the output ports 150-160, depending on the position of the insert 120 within the housing 110.

The vent port 330 may be connected to the pipe 170 via a cylindrical member or pipe 180. The port 330 may be located within the vent cavity 380 (e.g., a groove on the exterior radial surface of the insert 110) that is able to selectively connect to one or more of the deselected output ports 150-160, such that air is able to pass through the vent channel 180.

The first channel 340 may align with lip 210 (and/or other appropriate elements). The second channel 350 may align with tabs 220 (and/or other appropriate elements). In some embodiments, either or both channels 340-350 may retain O rings, gaskets, etc. The one or more slots 360 may allow features such as tabs 220 to engage channel 350 in certain orientations. The one or more tabs 370 may engage with associated slots, lips, stops, and/or other appropriate elements of the housing 110. These features may together retain the insert 120 within the housing 110 such that the insert 120 is be able to rotate within the housing 110 at least from the first position to the second position. In some embodiments, the insert 120 may be able to be coupled to (or decoupled from) the housing 110 using pressure applied to the insert 120 along the axis of rotation.

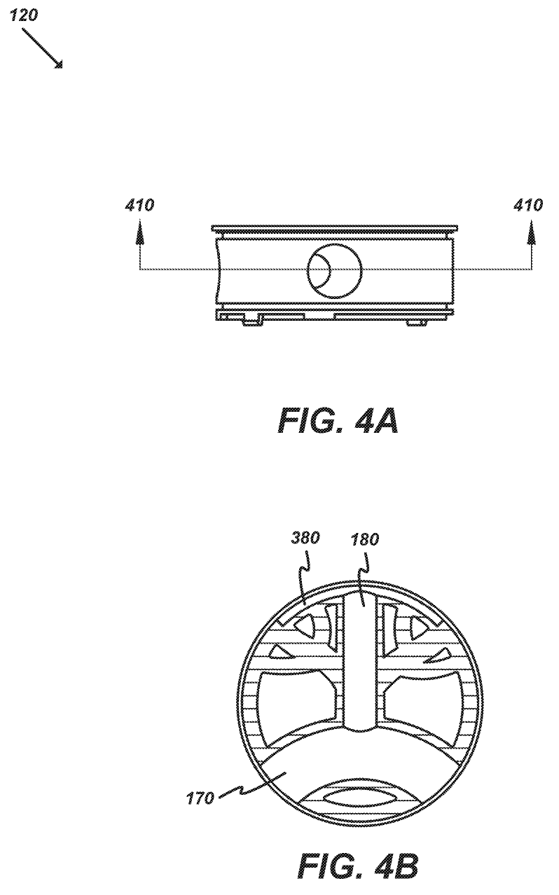

FIG. 4A illustrates a left side plan view of the greywater control valve insert 120. FIG. 4B illustrates a front elevation section view of the greywater control valve insert 120 along line 410. As shown, this view exposes the fluid channel 170, the vent channel 180, and the vent cavity 380.

Although the valve 100 has been described by reference to various exemplary features, one of ordinary skill in the art will recognize that the valve may be implemented in various different ways without departing from the scope of the disclosure. For instance, the fluid channel 170 may form a right-angle or “elbow” (and/or other appropriate shapes) rather than the smoothly curved connector shown.

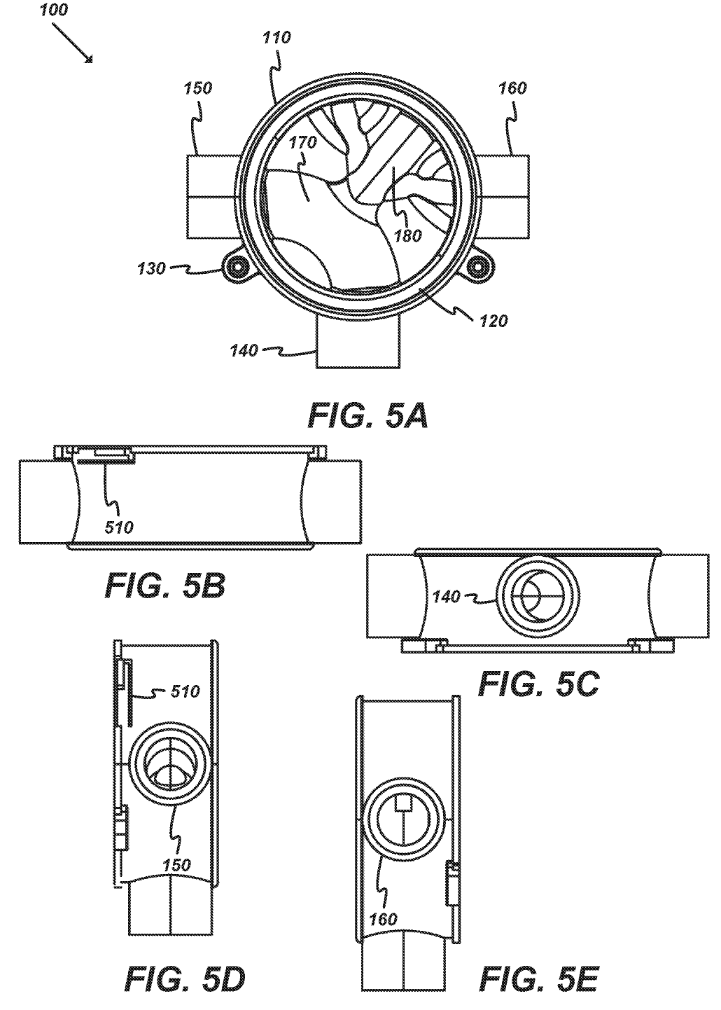

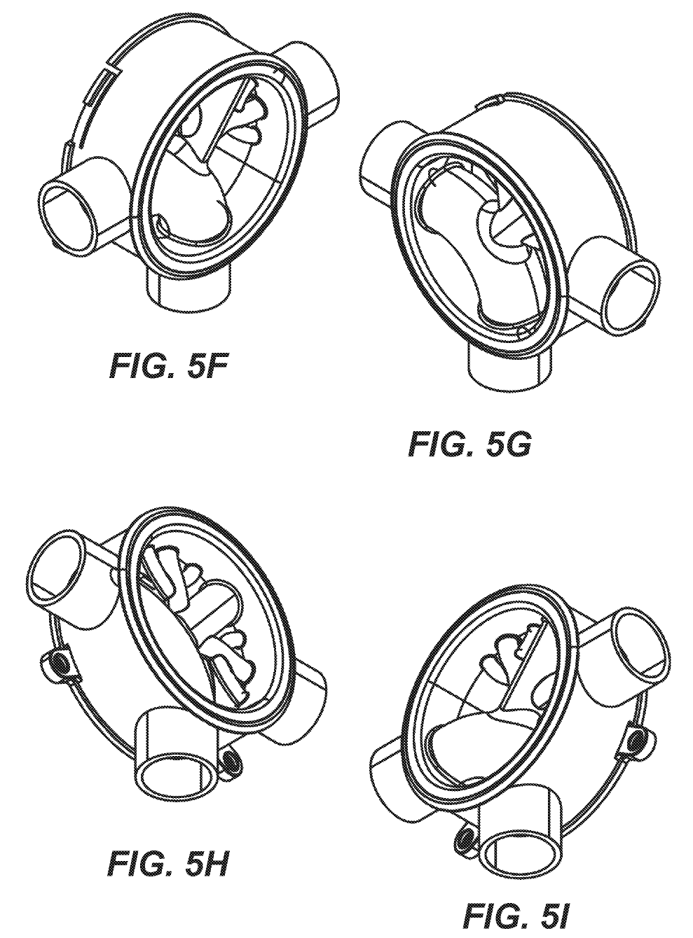

FIG. 5A illustrates a front elevation view of a quick release greywater control valve 100 according to an exemplary embodiment. FIG. 5B illustrates a top plan view of the quick release greywater control valve 100. FIG. 5C illustrates a bottom plan view of the quick release greywater control valve 100. FIG. 5D illustrates a left side elevation view of the quick release greywater control valve 100. FIG. 5E illustrates a right side elevation view of the quick release greywater control valve 100. FIG. 5F illustrates a top, front, left side perspective view of the quick release greywater control valve 100. FIG. 5G illustrates a top, front, right side perspective view of the quick release greywater control valve 100. FIG. 5H illustrates a bottom, front, left side perspective view of the quick release greywater control valve 100. FIG. 5I illustrates a bottom, front, right side perspective view of the quick release greywater control valve 100.

As shown, the valve of FIG. 5A-FIG. 5I may be similar to the valve of FIG. 1A-FIG. 1I, with the addition of quick-release latch 510. The latch may engage a lip or other appropriate receptacle of insert 120.

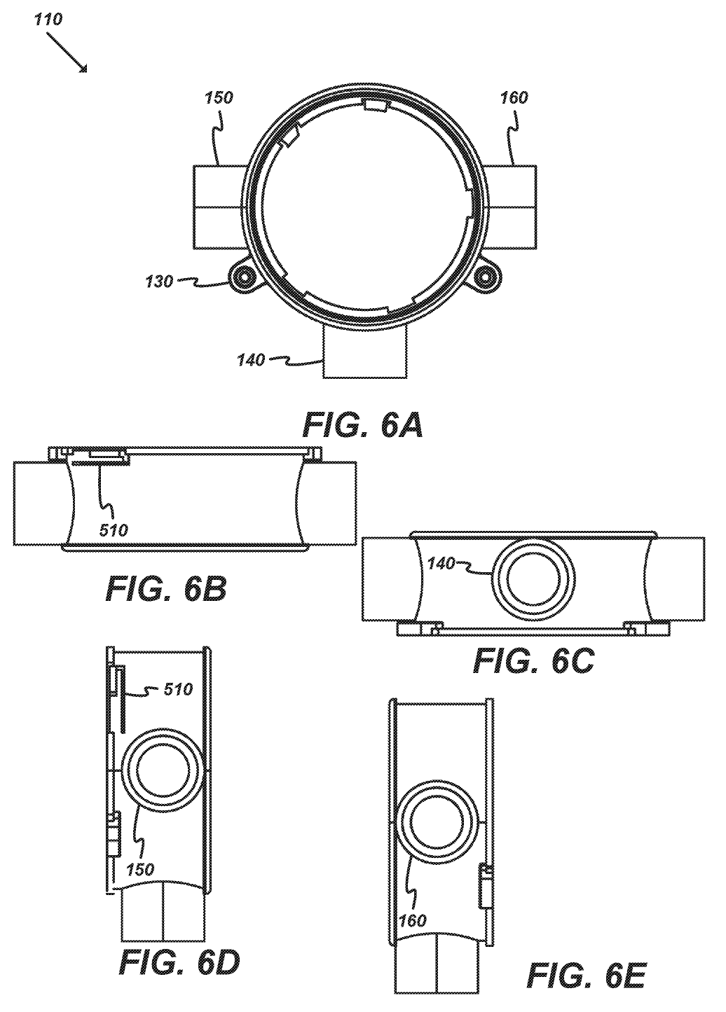

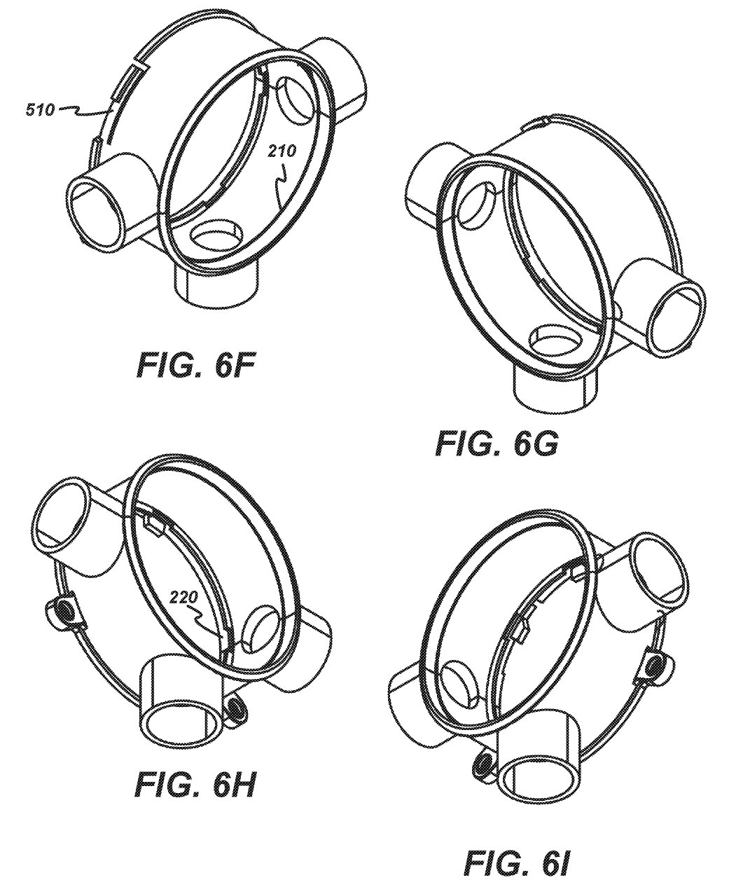

FIG. 6A illustrates a front elevation view of a quick release greywater control valve housing of the greywater control valve 100. FIG. 6B illustrates a top plan view of the quick release greywater control valve housing 110. FIG. 6C illustrates a bottom plan view of the quick release greywater control valve housing 110. FIG. 6D illustrates a left side elevation view of the quick release greywater control valve housing 110. FIG. 6E illustrates a right side elevation view of the quick release greywater control valve housing 110. FIG. 6F illustrates a top, front, left side perspective view of the quick release greywater control valve housing 110. FIG. 6G illustrates a top, front, right side perspective view of the quick release greywater control valve housing 110. FIG. 6H illustrates a bottom, front, left side perspective view of the quick release greywater control valve housing 110. FIG. 6I illustrates a bottom, front, right side perspective view of the quick release greywater control valve housing 110.

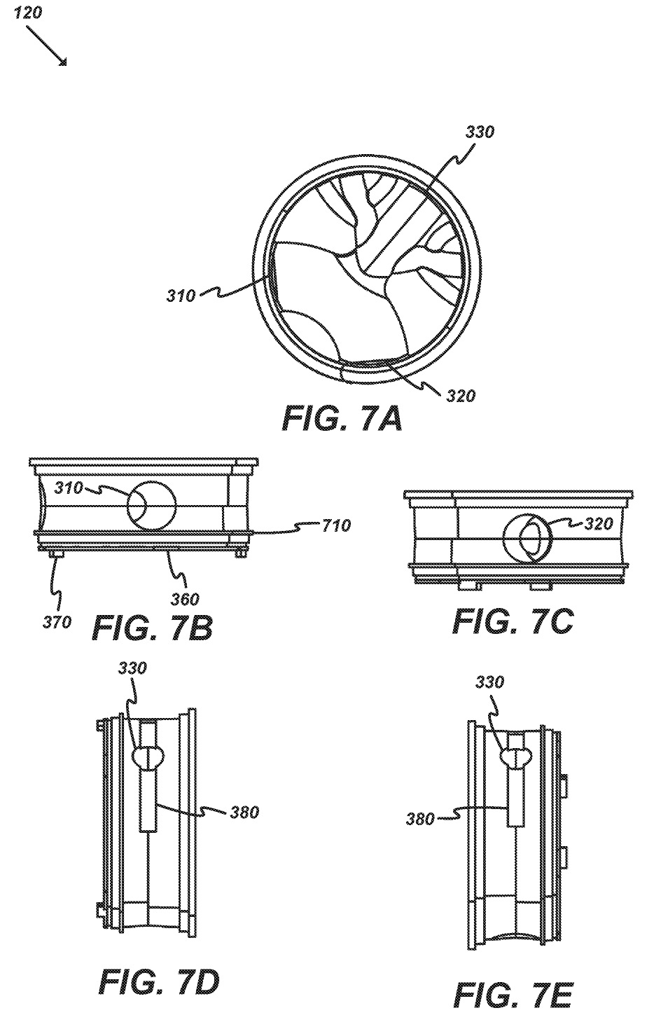

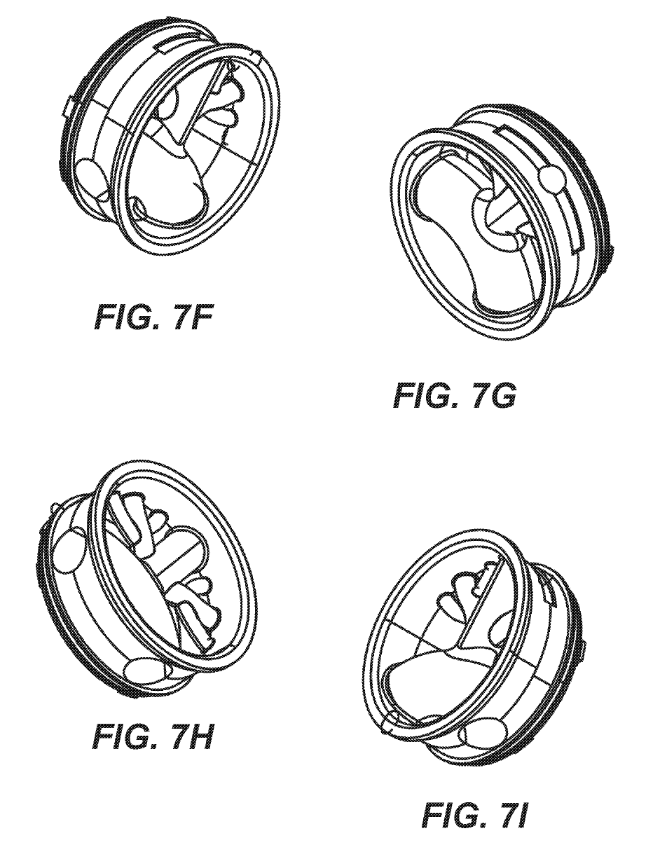

FIG. 7A illustrates a front elevation view of a quick release greywater control valve insert of the quick release greywater control valve 100. FIG. 7B illustrates a bottom, left plan view of the quick release greywater control valve insert 120. FIG. 7C illustrates a bottom, right plan view of the quick release greywater control valve insert 120. FIG. 7D illustrates a left side elevation view of the quick release greywater control valve insert 120. FIG. 7E illustrates a right side elevation view of the quick release greywater control valve insert 120. FIG. 7F illustrates a top, front, left side perspective view of the quick release greywater control valve insert 120. FIG. 7G illustrates a top, front, right side perspective view of the quick release greywater control valve insert 120. FIG. 7H illustrates a bottom, front perspective view of the quick release greywater control valve insert 120. FIG. 7I illustrates a bottom, front, right side perspective view of the quick release greywater control valve insert 120.

As shown, the insert may include a lip 710 that may engage a portion of quick release tab 510. The lip 710 may include a recess, slot, etc. associated with the tab 510. Different embodiments may include different latches, lips, tabs, receptacles, etc., as appropriate to allow the insert 120 to be released from the housing 110. In some embodiments, the insert 120 may slide into the housing 110 and turn until the release tab 510 is forced up. A lever may be pushed to lift the tab and allow the insert 120 to rotate in the opposite direction for removal from the housing 110.

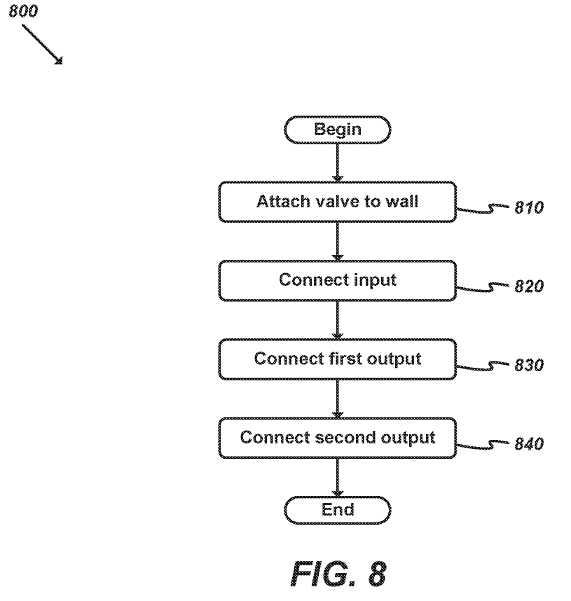

FIG. 8 illustrates a flow chart of an exemplary greywater control valve installation process 800 of some embodiments.

As shown, the process may attach (at 810) the valve 100 to a wall or other appropriate support surface. The valve may be attached using elements such as elements 130. The valve 100 may be mounted at an appropriate height such that a user may select between the available outputs.

Next, the process may connect (at 820) the input port 140 to the greywater supply such as a washing machine drain. Such a connection may be made in various appropriate ways (e.g., compression fit, solder, etc.).

The process may then connect (at 830) the first output port 150 to an appropriate system such as an indoor plumbing system (e.g., leading to a sewer or septic tank).

Next, the process may connect (at 840) the second output port 160 to an appropriate greywater usage system, such as an irrigation system. The process may then end.

During operation, the insert 110 may be rotated from the first position to the second position (or vice versa) in order to select the desired output. Some embodiments may include various stops and/or guides that ensure proper positioning for each selection possibility, where the number of available selections may depend on the number of available outputs.

The foregoing relates to illustrative details of exemplary embodiments and modifications may be made without departing from the scope of the disclosure as defined by the following claims.

We claim:

1. A greywater control valve (100) comprising:
a housing (110) having an input port (140) and at least two output ports (150, 160); and
an insert (120) coupled to the housing, the insert comprising a port connection element (170) and a vent channel (180).

2. The greywater control valve of claim 1, wherein the insert is able to rotate within the housing between at least a first position and a second position.

3. The greywater control valve of claim 2, wherein:
the first position connects the input port to a first output port from the at least two output ports, and
the second position connects the input port to a second output port from the at least two output ports.

4. The greywater control valve of claim 1, wherein the input port is located along a first axis and the at least two output ports are located along a second axis that is perpendicular to the first axis.

5. The greywater control valve of claim 1, wherein the vent channel comprises a vent cavity along an exterior radial surface of the insert.

6. The greywater control valve of claim 1, wherein at least one of the input port and the at least two output ports comprises a tapered cylinder.

7. The greywater control valve of claim 1 further comprising at least one wall mount feature able to secure the greywater control valve to a flat surface.

8. A rotary greywater control valve (100) comprising:
a housing (110) including:
an input port (140);
a first output port (150); and
a second output port (160); and
an insert (120) that rotates within the housing, the insert including:
a connection channel (170) that couples the input port to one of the first output port and the second output port; and
a vent channel (180) that couples the connection channel to one of the first output port and the second output port.

9. The rotary greywater control valve of claim 8, wherein the insert is able to rotate within the housing between at least a first position and a second position.

10. The rotary greywater control valve of claim 9, wherein:
the first position connects the input port to the first output port, and
the second position connects the input port to the second output port.

11. The rotary greywater control valve of claim 8, wherein the input port is located along a first axis and the first output port and the second output port are located along a second axis that is perpendicular to the first axis.

12. The rotary greywater control valve of claim 8, wherein the vent channel comprises a vent cavity along an exterior radial surface of the insert.

13. The rotary greywater control valve of claim 8, wherein at least one of the input port, the first output port, and second output port comprises a tapered cylinder.

14. The rotary greywater control valve of claim 8, wherein the insert further comprises a quick release latch.

15. A fluid control valve (100) comprising:
an input port (140) comprising a cylindrical element located along a first axis;
a first output port (150) comprising a first cylindrical element located along a second axis that is perpendicular to the first axis;
a second output port (160) comprising a second cylindrical element located along the second axis; and
a fluid channel (170) that selectively couples the input port to one of the first output port and the second output port.

16. The fluid control valve of claim 15 further comprising a vent channel that couples the fluid channel to one of the first output port and the second output port.

17. The fluid control valve of claim 15 wherein the fluid control valve has:
a first position that connects the input port to the first output port via the fluid channel and connects the vent channel to the second output port, and
a second position that connects the input port to the second output port via the fluid channel and connects the vent channel to the first output port.

18. The fluid control valve of claim 15, wherein the fluid channel traverses a ninety degree arc across a rotary front face of the fluid control valve.

19. The fluid control valve of claim 15, wherein the vent channel comprises a vent cavity along an exterior radial surface of a rotary insert of the fluid control valve.

20. The fluid control valve of claim 15, wherein at least one of the input port, the first output port, and second output port comprises a tapered cylinder.
